(19) United States
(12) Patent Application Publication
(10) Pub. No.: US 2023/0065652 A1
(43) Pub. Date: Mar. 2, 2023

(54) MICROFLUIDIC DEVICE BEING CAPABLE OF INITIATING SEQUENTIAL FLOW FROM MULTIPLE RESERVOIRS

(71) Applicant: KOREA INSTITUTE OF MACHINERY & MATERIALS, Daejeon (KR)

(72) Inventors: Yeong-Eun YOO, Daejeon (KR); Kwanoh KIM, Daejeon (KR); Do Hyun KANG, Daejeon (KR); Jaesung YOON, Daejeon (KR)

(21) Appl. No.: 17/894,240

(22) Filed: Aug. 24, 2022

(30) Foreign Application Priority Data
Aug. 25, 2021 (KR) 10-2021-0112382

(51) Int. Cl. B01L 3/00

(52) U.S. Cl. CPC B01L 3/502738; B01L 3/50273; B01L 3/502715; B01L 2300/049; B01L 2300/0681; B01L 2400/049; B01L 2400/082

(57) ABSTRACT

The microfluidic device capable of initiating sequential flow according to the present invention includes: a main flow path in which a suction port for sucking the fluid with a negative pressure is formed at one end; a plurality of reservoirs that supply a fluid stored therein to the main flow path through an outlet by the negative pressure applied to the suction port, and are connected to a plurality of different points of the main flow path; and a blocking element that blocks the inflow of external air to the main flow path through the outlet when all the fluid in the reservoir flows out, wherein the fluid stored in a plurality of the reservoirs may flow sequentially.

### CROSS-REFERENCE TO RELATED APPLICATION

This application claims priority to and the benefit of Korean Patent Application No. 10-2021-0112382 filed in the Korean Intellectual Property Office on Aug. 25, 2021, the entire contents of which are incorporated herein by reference.

### TECHNICAL FIELD

The present invention relates to a microfluidic device capable of initiating sequential flow. More particularly, the present invention relates to a microfluidic device that allows a fluid stored in a plurality of reservoirs to flow sequentially by suction force such that processes such as mixing, washing, and reaction occur sequentially in a single device.

### BACKGROUND ART

For a diagnosis of pathogens or disease markers, sample pretreatment such as dissolving, extraction, filtration, and enrichment of cells, bacteria, viruses, proteins, and dielectric materials contained in the sample, and immunoassay or gene amplification reaction, and the like are performed. In this case, processes such as mixing, reaction, and washing with various reagents are repeatedly applied.

Conventionally, such a process has required manual work of workers using small vials and pipettes that can contain liquids, which causes deviations depending on workers and inefficient diagnosis for a large number of people.

In addition, although some automated process using a robot-type large device, and the like is available, there is a drawback that the cost is high and the space occupied by the device is very large. Furthermore, it is necessary to apply a complex pump and valve system, and it is difficult to automate the entire process such that there is still a large dependence on workers.

### DISCLOSURE

### Technical Problem

One aspect of the present invention is provided to solve that above-stated conventional problem is to provide a microfluidic device capable of initiating sequential flow such that a fluid stored in a plurality of reservoirs can start a flow sequentially and react using a negative pressure applied from a suction port of one end of a flow path, thereby performing a sample processing protocol formed of several steps in a single microfluidic device.

The problems to be solved by the present invention are not limited to the problems mentioned above, and other problems not mentioned will be clearly understood by a person of ordinary skill in the art from the description below.

### Technical Solution

A microfluidic device that can initiate a sequential flow according to an embodiment of the present invention includes: a main flow path in which a suction port for sucking the fluid with a negative pressure is formed at one end; a plurality of reservoirs that supply a fluid stored therein to the main flow path through an outlet by the negative pressure applied to the suction port, and are connected to a plurality of different points of the main flow path; and a blocking element that blocks the inflow of external air to the main flow path through the outlet when all the fluid in the reservoir flows out, wherein the fluid stored in a plurality of the reservoirs may flow sequentially.

A reaction chamber may be formed in the middle of the main flow path between the suction port and a first point where the reservoir is connected closest to the main flow path from the suction port to mix and react the fluid.

A membrane may be formed in a middle portion of the main flow path between a first point where the reservoir is connected closest to the main flow path from the suction port and the suction port.

Here, the main flow path may have different flow resistance depending on a distance from the suction port.

In the main flow path, flow resistance of a partial flow path between two adjacent points where the reservoirs are connected may be formed differently.

The main flow path may decrease the flow resistance by increasing the size of the partial flow path or shortening a length of the partial flow path as the distance from the suction port increases.

The main flow path may control the flow of the fluid by connecting a partial flow path between two points where the reservoirs are connected with a plurality of microfluidic paths.

The connecting flow path connecting the outlet of the reservoir and the main flow path may be formed such that the size of the flow path is gradually increased or decreased.

The connecting flow path connecting the outlet of the reservoir and the main flow path may be formed to protrude into the reservoir.

The reservoir may be formed above the main flow path and supplies fluid vertically downward to the main flow path.

The reservoir may be formed on one side of the main flow path to horizontally supply fluid to the main flow path.

The blocking element may include a blocking bead that floats on the fluid in the reservoir and descends as the fluid flows out through the outlet to block the outlet.

The blocking element may include a blocking cover that closes an open top of the reservoir and is formed of a material with elasticity, and contracts toward the outlet after the fluid flows out through the outlet and blocks air inflow to the main flow path.

The blocking element may be formed with a valve that blocks the outlet or blocks the reservoir from the outside, and the valve may operate automatically by a control signal or manually.

The main flow path may be formed to increase or decrease a size of the flow path locally to control the flow characteristic.

A step may be formed in the main flow path to increase or decrease a size of the flow path to thereby control the flow characteristics.

A plurality of reservoirs may be connected to a single point on the main flow path.

One end of the main flow path may be branched to form a plurality of suction ports.

In the microfluidic device capable of initiating sequential flow according to the embodiment of the present invention, the fluid stored in the plurality of reservoirs can automatically start a flow sequentially and react without a pump or a valve for flow through micro-fluidic channel by the negative pressure applied from the suction port of one end of the flow path such that a sample processing protocol formed of several steps can be performed in a single microfluidic device. Accordingly, there is merit in that diagnosis analysis can be performed at various sites rather than in a specialized analysis room by minimizing the manpower, time, cost, and space required for sample processing.

### DESCRIPTION OF THE DRAWINGS

FIG. 1 is a cross-sectional view of a basic configuration of a microfluidic device capable of initiating sequential flow according to an embodiment of the present invention.

FIG. 2 shows an operation of the microfluidic device of FIG. 1.

FIG. 3 is provided for a description of a configuration and operation of a blocking element of the microfluidic device capable of initiating sequential flow according to the embodiment of the present invention.

FIG. 4 is provided for a description of a configuration and operation of a blocking element of a microfluidic device capable of initiating sequential flow according to an embodiment of the present invention.

FIG. 5 is a photograph showing a sequential flow experiment by fabricating a microfluidic device capable of initiating sequential flow manufactured according to an embodiment of the present invention.

FIG. 6 shows a microfluidic device capable of initiating sequential flow in which a reaction chamber is formed.

FIG. 7 and FIG. 8 show a microfluidic device capable of initiating sequential flow configured to vary the flow resistance of partial flow paths between reservoirs.

FIG. 9 shows a microfluidic device capable of initiating sequential flow, formed to control a flow characteristic of a fluid by differentiating the number of flow paths between reservoir.

FIG. 10 shows various embodiments of a microfluidic device capable of initiating sequential flow, formed to control a flow characteristic of a fluid by changing the shape of the flow path.

FIG. 11 shows a microfluidic device capable of initiating sequential flow, in which a reservoir is formed at one side of a main flow path in the microfluidic device.

FIG. 12 shows a microfluidic device capable of initiating sequential flow, in which a plurality of reservoirs are connected to a single point of a main flow path.

FIG. 13 shows a microfluidic device capable of initiating sequential flow in a form in which a plurality of suction ports are formed.

FIG. 14 and FIG. 15 show a shape of a connection flow path between the reservoir and the main flow path.

### MODE FOR INVENTION

The specific details of the embodiments are included in the detailed description and drawings.

Advantages and features of the present invention, and a method for achieving them will become apparent with reference to the embodiments described below in detail with the accompanying drawings. However, the present invention is not limited to the embodiments disclosed below, but may be implemented in a variety of different forms. The present embodiments only allow the disclosure of the present invention to be complete, and are provided to fully inform the scope of the invention to an ordinary skill, and the present invention is only defined by the scope of the claim. The same reference numerals refer to the same constituent elements throughout the specification.

Hereinafter, the present invention will be described with reference to drawings for describing a microfluidic device capable of initiating sequential flow according to embodiments of the present invention.

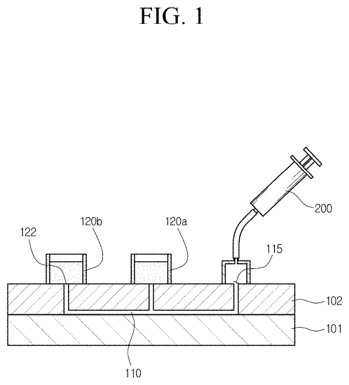

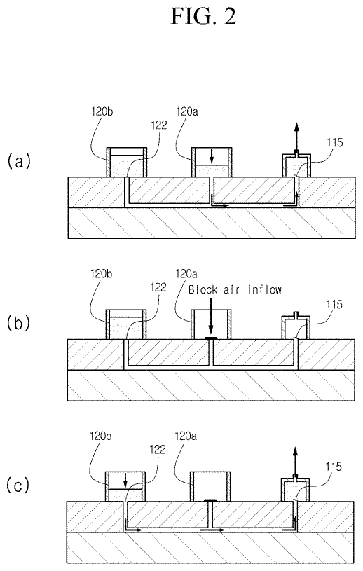

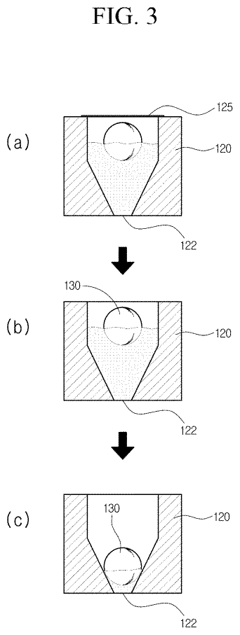

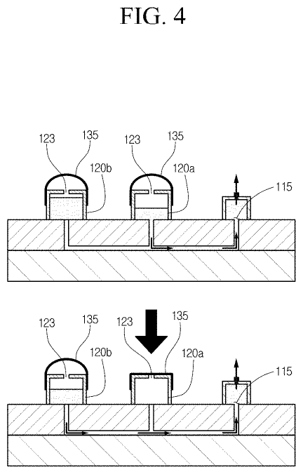

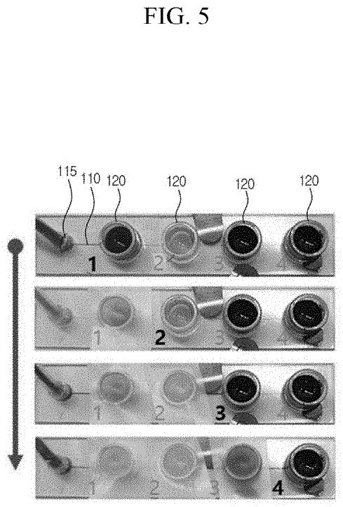

FIG. 1 is a cross-sectional view of a basic configuration of a microfluidic device capable of initiating sequential flow according to an embodiment of the present invention, FIG. 2 shows an operation of the microfluidic device of FIG. 1., FIG. 3 is provided for a description of a configuration and operation of a blocking element of the microfluidic device capable of initiating sequential flow according to the embodiment of the present invention, FIG. 4 is provided for a description of a configuration and operation of a blocking element of a microfluidic device capable of initiating sequential flow according to an embodiment of the present invention, and FIG. 5 is a photograph showing a sequential flow experiment by fabricating a microfluidic device capable of initiating sequential flow manufactured according to an embodiment of the present invention.

A microfluidic device according to the present invention performs a function of processing various biological/chemical reaction processes for diagnosis, examination, analysis, and the like in a device or a chip unit. A microfluidic device is variously called a biochip, a diagnosis device, a lab on a chip, or a micro electro mechanical systems (MEMS) device, and a micro-sized or nano-sized micro-channel that allow the sample in a fluid state to flow is formed.

A microfluidic device according to an embodiment of the present invention may be configured to include a main flow path 110, a plurality of reservoirs 120, and a blocking element.

The main flow path 110 is a microchannel formed inside the device, and a suction port 115 may be formed at one end. The suction port 115 communicates with the outside of the device. Therefore, the fluid in the reservoir 120 can be discharged to the suction port 115 by applying a negative pressure to the inside of the main flow path 110 through the suction port 115 using a syringe pump 200 or the like. In the drawing, a separate protruding structure for connection between the syringe pump 200 and the suction port 115 can be formed to protrude to the top of the microfluidic device.

In the present embodiment, a negative pressure is applied to the inside of the main flow path 110 by using the syringe pump 200 as an example, but it is not limited thereto, and a vacuum pump or a vacuum chamber can be connected to the suction port 115 to apply a negative pressure to the inside of the main flow path 110.

The main flow path 110 may be a nano or micro-sized flow path, but may not be limited thereto. The main flow path 110 may be formed in various shapes such as a straight-line shape, a bent shape, and a curved line shape.

To form a flow path inside the microfluidic device, as shown in FIG. 1, the microfluidic device can be formed of multi-layered substrates 101 and 102. As shown in the drawing, the microfluidic device having a flow path formed therein by bonding the base substrate 101 forming a bottom of the main flow path 110 and the flow path substrate 102 having an intaglio groove or a flow path penetrating the inside forming the main flow path 110 can be easily formed. Although it is not illustrated, a groove forming the main flow path 110 is formed on an upper surface of the base substrate 101 of FIG. 1, the flow path substrate 102 covering an upper portion of the base substrate 101 forms an upper surface of the main flow path 110, and a flow path passing through the inside is formed on the flow path substrate 102. A method of forming the flow path inside the microfluidic device is not limited to the above-described form, and other known techniques may be used.

The reservoir 120 stores various fluids for mixing, washing, reaction, and the like, and the fluid stored inside may be supplied to the main flow path 110 through an outlet 122. The reservoir 120 is connected to the main flow path 110, and when the negative pressure is applied to the inside of the device from the suction port 115, the negative pressure is applied through the outlet 122 below the reservoir 120, and the pressure difference between the top and bottom of the reservoir 120 causes the fluid inside reservoir 120 to be discharged to the main flow path 110 through the outlet 122.

In the present embodiment, the reservoir 120 is formed in an upper portion of the main flow path 110 and may supply the fluid stored inside the reservoir 120 to the main flow path 110 positioned vertically below through the outlet 112 formed at a lower end of the reservoir 120.

In this case, in the present invention, a plurality of reservoirs 120 may be connected to different points of the main flow path 110 to be disposed. In FIG. 1, two reservoirs 120 are disposed at different points on the main flow path 110, but this is an example, and many more reservoirs 120 may be disposed at different positions in the main flow path 110.

The reservoir 120 may be formed in a protruding form to the top of the microfluidic device, but is not limited thereto, and may be formed in a form in which the reservoir 120 is disposed inside the device.

The blocking element blocks the outlet 122 such that external air does not flow into the microfluidic device through the outlet 122 when all the fluid in the reservoir 120 flows out or blocks the reservoir 120 from the outside (e.g., as shown in FIG. 4, an air inflow hole 123 of the reservoir 120). In this case, the blocking element may include a valve that blocks the outlet 122 or blocks the reservoir 120 from the outside, and the valve may be operated by a control signal or may be configured to operate manually.

In the present embodiment, it is possible to automatically block the inflow of air into the device when all of the fluid in the reservoir 120 is discharged without a separate control signal. Hereinafter, the structure of the blocking element will be described.

As shown in FIG. 3, the blocking element floats on the fluid in the reservoir 120 by buoyancy, and may include a blocking bead 130 that gradually descends together with the fluid as the fluid flows out to the main flow path 110 through the outlet 122 of the reservoir 120 and blocks the outlet 122 when the fluid in the reservoir 120 is exhausted.

The blocking bead 130 may be formed in a spherical shape, but is not limited thereto.

The blocking bead 130 is preferably formed of a material having a lower density than the fluid in the reservoir 120 such that it can float on the fluid in the reservoir 120. Alternatively, although the blocking bead 130 is formed of a material having a greater density than that of the fluid in the reservoir 120, the inside is formed in an empty form and may float in the fluid. For example, the blocking bead 130 may be formed of a hollow glass bead, a hollow plastic bead, or a hollow metal bead.

In this case, it is preferable that a lower end of the reservoir 120 has an inclined surface such that the internal space decreases as it goes down, and the outlet 122 connected to the main flow path 110 is formed at a lower end of the inclined surface. The shape of the inclined surface is not limited to the illustrated shape, and various modifications such as a curved line shape may be possible.

As such, as the lower end of the reservoir 120 is formed such that the size of the internal space gradually decreases as it goes down, the fluid flows out through the outlet 122 and thus when the blocking bead 130 moves downward, the downward movement of the blocking bead 130 can be guided, and the blocking bead 130 naturally contacts an inner surface of a lower portion of the reservoir 120 and can block the outlet 122 at a proper position.

For diagnosis and the like, it is necessary to sequentially perform mixing of the pretreatment steps using a dilute solution or buffer solution and the like, and reactions through reaction reagents. A flow process of the fluid using the microfluidic device capable of initiating sequential flow according to the present invention will be described.

In the plurality of reservoirs 120, the blocking bead 130 is provided in advance, and in a state in which the blocking bead 130 is floating in the fluid, as shown in (a) of FIG. 3, an open surface of the top of the reservoir 120 may be provided in a closed state with a film 125, and the like.

As shown in (b) of FIG. 3, when the film 125 is removed and the negative pressure is applied to the inside of the main flow path 110 through the suction port 115 using the syringe pump 200, the fluid stored in the reservoir 120a disposed to the position closest to the main flow path 110 flows out through the outlet 122, and a level of the fluid in the reservoir 120 is decreased (FIG. 2 (a)). In this case, as the level of the fluid descends, the blocking bead 130 floating in the fluid is guided to the inclined surface positioned at the lower end of reservoir 120a and descends together, and stops the descending when contacting the inner surface of the inclined surface (FIG. 3 (c)) such that an upper portion of the output 122 is blocked, thereby blocking the output 122.

In this case, when the negative pressure is continuously applied through the syringe pump 200, the remaining fluid positioned under the blocking bead 130 may finally flow out.

In this way, when all of the fluid stored in the reservoir 120a flows out and the outlet 122 of the reservoir 120a is blocked (FIG. 2 (b)), the fluid in the reservoir 120b disposed from the suction port 115 to the next position may be discharged by the operation of FIGS. 3 (b) and (c).

When the blocking element is not formed, the air inflows into the main flow path 110 after all the fluid in the reservoir 120a positioned first from the suction port 115 is exhausted and thus the negative pressure is not applied to the reservoir 120b in the next position to suck the fluid.

As described, in the present invention, when all of the fluid in the reservoir 120 is exhausted, the blocking bead 130 descends without a driving device to block the outlet 122.

In order to secure air-tightness at the contact area between the blocking bead 130 and the inner surface of the reservoir 120, the blocking bead 130 may be formed of an elastic material. Alternatively, the exterior side of the blocking bead 130 may be coated with an elastic material such as rubber or silicone. As described, as the blocking bead 130 has the property of elasticity, when the blocking bead 130 contacts the inner surface of the reservoir 120, the air-tightness between the blocking bead 130 and the inner surface of the reservoir 120 can be improved due to the elastic deformation of the exterior side of the blocking bead 130.

Another embodiment of the blocking element will be described.

As shown in FIG. 4, a blocking element may include a blocking cover 135 that closes an open top of a reservoir 120 and is formed of a material with rubber-like elasticity. When all the fluid inside the reservoir 120 is discharged and exhausted, the air inside the blocking cover 135 is sucked and the blocking cover 135 can be contracted. An air inflow hole 123 at the top of the reservoir 120 is blocked by the contraction of the blocking cover 135, and when all the air inside the reservoir 120 is leaked out, the inflow of any more air into the main flow path 110 through the outlet 122 can be blocked.

Not as shown in the drawings, an upper end of the reservoir 120 is formed in an open state without forming a separate air inflow hole 123 at the upper end of the reservoir 120 and the upper end of the reservoir is closed only with the blocking cover 135, and thus the blocking cover 135 may directly block an outlet 122 by contraction of the blocking cover 135.

As described, when all the fluid in the reservoir 120 is exhausted, the blocking cover 135 is contracted by the suction force by the negative pressure, and additional air inflow may be blocked after a predetermined amount of air inside the blocking cover 135 inflows into the main flow path 110, and therefore, by the operation of the blocking cover 135, the fluid in the reservoir 120b that is subsequently disposed may flow.

FIG. 5 shows a result of experiments of the flow of fluid using a microfluidic device capable of initiating sequential flow actually manufactured according to the present invention. Four reservoirs 120 are disposed along the main flow path 110, and reagents of different colors are supplied from the respective reservoirs 120. When a negative pressure is applied through a suction port 115 on the left side, the reagents in the reservoir 120 leak out, and after all the reagents in the reservoirs 120 are out, the reagents in the reservoirs 120 leak out such that it can be seen that the reagents in the first to fourth reservoirs 120 flow sequentially and flow into the suction port 115.

Hereinafter, numerous exemplary variations of a microfluidic device capable of initiating sequential flow described with reference to FIG. 1 to FIG. 5 will be described.

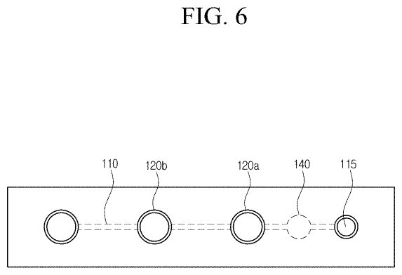

FIG. 6 shows a microfluidic device capable of initiating sequential flow, in which a reaction chamber is formed.

As shown in the drawing, a reaction chamber 140 for reacting by mixing fluids in the middle of a main flow path 110 between a first point where a first reservoir 120a is connected to the main flow path 110 from the suction port 115 and the suction port 115 may be formed. For example, when negative pressure is applied through the suction port 115, at least a part of the reagent flowing out from the first reservoir 120a is not discharged through the suction port 115, but is reacted by an external force (e.g., a magnetic field, an electric field, gravity, or a membrane to be described later) to maintain in the chamber 140, and as a method for allowing the reagent flowing out from a second reservoir 120b to reach the reaction chamber 140, a plurality of reagents stored in each of the reservoirs 120 may be reacted within the reaction chamber 140. The reaction chamber 140 may be formed in a form having a space of a predetermined size in which the fluid is stored, but is not limited thereto, and may be formed in the form of an oblique line.

In addition, although not shown, a membrane structure may be formed in a middle portion of the main flow path 110 between the first point and the suction port 115. The membrane structure stacks ultrafine particles in the flow path or forms a membrane to allow only materials of a predetermined size or less to pass through the flowing fluid, or to separate materials in the fluid by using electrical charging characteristics.

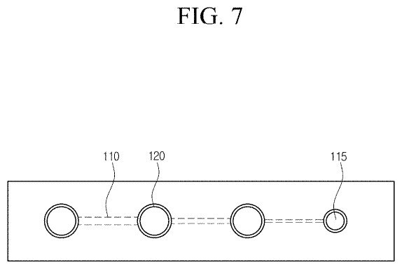

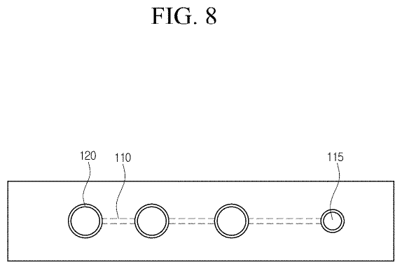

FIG. 7 and FIG. 8 show a microfluidic device capable of initiating sequential flow configured to vary the flow resistance of partial flow paths between reservoirs.

When the same negative pressure is applied through the suction port 115, the fluid suction force from the reservoir 120 positioned farther away may be relatively weak compared to the suction force from the reservoir 120 positioned close. Accordingly, in the present invention, the flow resistance is formed differently according to the position of the main flow path 110 such that the fluid can flow relatively easily even for the reservoir 120 located far from the suction port 115, and thus the flow characteristics can be designed to be uniform throughout the entire main flow path 110. Alternatively, the flow characteristics may be controlled differently by artificially forming different flow resistances according to the position of the main flow path 110.

In the present invention, the main flow path 110, which is the path through which the fluid flows from the reservoir 120 to the suction port 115, may have different flow resistance depending on a distance from the suction port 115. For example, when a flow path between two adjacent points where two reservoirs 120 are connected in the main flow path 110 is referred to as a partial flow path, the flow resistance of each partial flow path may be formed differently. For example, as shown in FIG. 7, as the distance from the suction port 115 increases, the main flow path 110 is formed such that the flow resistance is reduced by increasing the size of the partial flow path (the ratio of the cross-sectional area vertical to the flow direction to the perimeter of the cross-sectional area; hydraulic diameter), and thus the flow characteristic can be controlled to be uniform for the entire main flow path 110.

Alternatively, as shown in FIG. 8, as the distance from the suction port 115 increases, the length of the partial flow path may be shortened to decrease the flow resistance.

As described, in the present invention, the flow characteristic between each reservoir 120 and the suction port 115 can be controlled by designing the size or length of the partial flow differently.

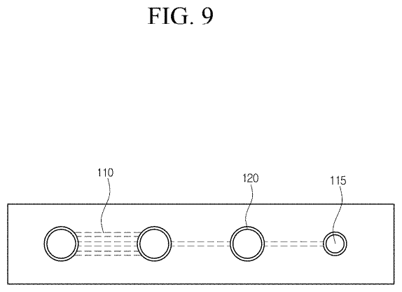

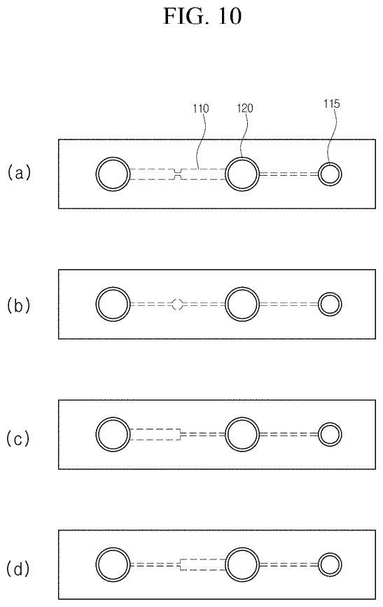

FIG. 9 shows a microfluidic device capable of initiating sequential flow, formed to control a flow characteristic of a fluid by differentiating the number of flow paths between reservoir 120, and FIG. 10 shows various embodiments of a microfluidic device capable of initiating sequential flow, formed to control a flow characteristic of a fluid by changing the shape of the flow path.

As shown in FIG. 9, the flow characteristic of the fluid can be controlled by forming the main flow path 120 between the two points where the reservoir 120 is connected as a plurality of microfluidic paths. In this case, the flow rate and flow rate may be differently controlled according to the number of microchannels.

Alternatively, as shown in (a) and (b) of FIG. 10, in the main flow path 110, the flow characteristic can be controlled by locally increasing or decreasing the size of the flow path.

Alternatively, as shown in (c) and (d) of FIG. 10, a step may be formed to increase or decrease the size of the flow path, thereby controlling the flow characteristic of the fluid for a predetermined partial flow path of the main flow path 110.

As described, the flow characteristics can be controlled differently when the fluid stored in each reservoir 120 flows along the main flow path 110 toward the suction port 115 by variously changing the shape of the main flow path 110.

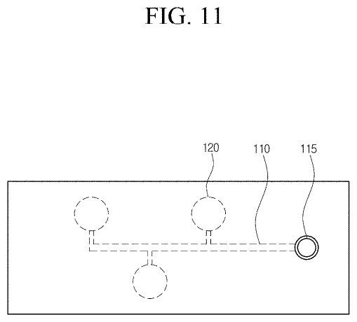

FIG. 11 shows a microfluidic device capable of initiating sequential flow, in which a reservoir is formed at one side of a main flow path in the microfluidic device.

The reservoir 120 was formed on the upper side of the main flow path 110 in the form to protrude on the top of the device in the embodiments described with reference to FIG. 1 to FIG. 5, but, in the present embodiment, the reservoir 120 is positioned inside the device and disposed to one side of the main flow path 110. Therefore, in the present embodiment, the fluid stored in the reservoir 120 may inflow into the main flow path 110 in the horizontal direction from one side of the main flow path 110.

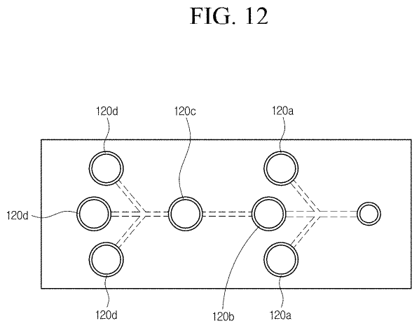

FIG. 12 shows a microfluidic device capable of initiating sequential flow, in which a plurality of reservoirs 120 are connected to a single point of a main flow path 110.

As shown in FIG. 12, a plurality of reservoirs 120 may be connected to a single point of a main flow path 110. When a plurality of reservoirs 120a are formed at the first point closest to the suction port 115 as shown in the drawing, the fluid may flow simultaneously from the plurality of reservoirs 120a connected to the first point when a negative pressure is applied through the suction port 115.

When the fluid stored in the plurality of reservoirs 120 connected to the first point is simultaneously discharged and exhausted, the fluid stored in reservoirs 120b and 120c connected to second and third points is sequentially inflowed, and when the inflow of the fluid is finished, the fluid stored in the plurality of reservoirs 120d connected to a fourth point may be simultaneously inflowed again.

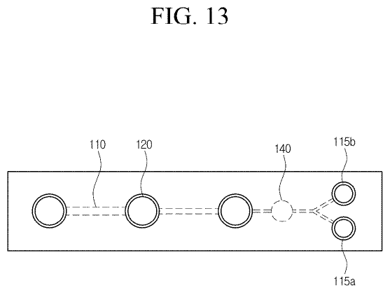

FIG. 13 shows a microfluidic device capable of initiating sequential flow in a form in which a plurality of suction ports 115 are formed.

As shown in the drawing, one end of a main flow path 110 may be branched to form a plurality of suction ports 115. In the drawing, two suction ports 115 are formed, but it is not limited thereto.

For example, reagents in the intermediate stage for the final reaction can be mixed and discharged through a first suction port 115a, and the final reaction product in a last reaction chamber 140 can be separately sucked and discharged through a second suction port 115b.

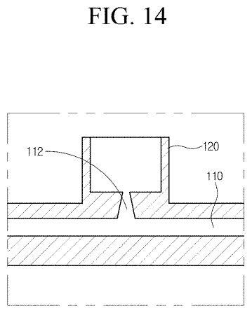

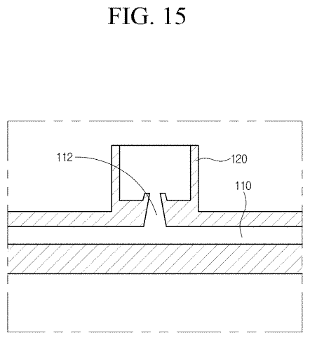

FIG. 14 and FIG. 15 show a shape of a connection flow path between the reservoir and the main flow path.

A connection flow path 112 connecting an outlet 122 of a reservoir 120 and a main flow path 110 may be formed to gradually increase in size as it goes down as shown in FIG. 14. As described, when the size of the connection flow path 112 is not constant and the size of the upper end is formed to be small, it is possible to prevent the fluid inside the reservoir 120 from easily inflowing into the connection flow path 112. That is, the suction pressure for inflowing the fluid inside the reservoir 120 to the connection flow path 122 can be increased.

In addition, on the contrary, the connecting flow path 112 may be formed such that the size of the flow path gradually decreases as it goes down.

As described, by controlling the shape of the connection flow path 112, it is possible to control the condition or characteristic of fluid inflow from the reservoir 120 to the main flow path 110.

As shown in FIG. 15, an upper end of the connection flow path 112 connecting the outlet 122 of the reservoir 120 and the main flow path 110 may be formed in a protruding form into the reservoir 120. As the connection flow path 112 is formed to protrude into the reservoir 120, it is possible to prevent the fluid inside the reservoir 120 from easily inflowing into the connection flow path 112.

The scope of the present invention is not limited to the above-described embodiment, but may be implemented in various forms within the scope of the appended claims. Without departing from the gist of the present invention claimed in the claimed range, any person of ordinary skill in the technical field to which the invention pertains shall be deemed to be within the range of the claimed range of the present invention to a range that can be modified by anyone.

### DESCRIPTION OF SYMBOLS

101: base substrate
102: flow path substrate
110: main flow path
112: connection flow path
115: suction port
120: reservoir
122: outlet
123: air inflow hole
125: film
130: blocking bead
135: blocking cover
140: reaction chamber
200: syringe pump

1. A microfluidic device capable of initiating sequential flow, comprising:
a main flow path in which a suction port for sucking the fluid with a negative pressure is formed at one end;
a plurality of reservoirs that supply a fluid stored therein to the main flow path through an outlet by the negative pressure applied to the suction port, and are connected to a plurality of different points of the main flow path; and
a blocking element that blocks the inflow of external air to the main flow path through the outlet when all the fluid in the reservoir flows out,
wherein the fluid stored in a plurality of the reservoirs flows sequentially.

2. The microfluidic device capable of initiating sequential flow of claim 1, wherein
a reaction chamber is formed in the middle of the main flow path between the suction port and a first point where the reservoir is connected closest to the main flow path from the suction port to mix and react the fluid.

3. The microfluidic device capable of initiating sequential flow of claim 1, wherein
a membrane is formed in a middle portion of the main flow path between a first point where the reservoir is connected closest to the main flow path from the suction port and the suction port.

4. The microfluidic device capable of initiating sequential flow of claim 1, wherein
the main flow path has different flow resistance depending on a distance from the suction port.

5. The microfluidic device capable of initiating sequential flow of claim 4, wherein
in the main flow path, flow resistance of a partial flow path between two adjacent points where the reservoirs are connected is formed differently.

6. The microfluidic device capable of initiating sequential flow of claim 5, wherein
the main flow path decreases the flow resistance by increasing the size of the partial flow path or shortening a length of the partial flow path as the distance from the suction port increases.

7. The microfluidic device capable of initiating sequential flow of claim 1, wherein
the main flow path controls the flow of the fluid by connecting a partial flow path between two points where the reservoirs are connected with a plurality of microfluidic paths.

8. The microfluidic device capable of initiating sequential flow of claim 1, wherein
the connecting flow path connecting the outlet of the reservoir and the main flow path is formed such that the size of the flow path is gradually increased or decreased.

9. The microfluidic device capable of initiating sequential flow of claim 1, wherein
the connecting flow path connecting the outlet of the reservoir and the main flow path is formed to protrude into the reservoir.

10. The microfluidic device capable of initiating sequential flow of claim 1, wherein
the reservoir is formed above the main flow path and supplies fluid vertically downward to the main flow path.

11. The microfluidic device capable of initiating sequential flow of claim 1, wherein
the reservoir is formed on one side of the main flow path to horizontally supply fluid to the main flow path.

12. The microfluidic device capable of initiating sequential flow of claim 1, wherein
the blocking element includes a blocking bead that floats on the fluid in the reservoir and descends as the fluid flows out through the outlet to block the outlet.

13. The microfluidic device capable of initiating sequential flow of claim 1, wherein
the blocking element includes a blocking cover that closes an open top of the reservoir and is formed of a material with elasticity, and contracts toward the outlet after the fluid flows out through the outlet and blocks air inflow to the main flow path.

14. The microfluidic device capable of initiating sequential flow of claim 1, wherein
the blocking element is formed with a valve that blocks the outlet or blocks the reservoir from the outside, and the valve operates automatically by a control signal or manually.

15. The microfluidic device capable of initiating sequential flow of claim 1, wherein
the main flow path is formed to increase or decrease a size of the flow path locally to control the flow characteristic.

16. The microfluidic device capable of initiating sequential flow of claim 1, wherein
a step is formed in the main flow path to increase or decrease a size of the flow path to thereby control the flow characteristics.

17. The microfluidic device capable of initiating sequential flow of claim 1, wherein
a plurality of reservoirs are connected to a single point on the main flow path.

18. The microfluidic device capable of initiating sequential flow of claim 1, wherein
one end of the main flow path is branched to form a plurality of suction ports.
